(19) United States
(12) Patent Application Publication
(10) Pub. No.: US 2026/0330124 A1
(43) Pub. Date: Oct. 22, 2026

(54) CONVERSATIONAL EDITOR

(71) Applicant: BOLD Limited, Hamilton (BM)

(72) Inventor: David NORDFORS, Los Altos, CA (US)

(21) Appl. No.: 19/182,472

(22) Filed: Apr. 17, 2025

(51) Int. Cl. G06F 40/166; G06F 40/40

(52) U.S. Cl. CPC G06F 40/166; G06F 40/40

(57) ABSTRACT

Certain aspects provide techniques for co-editing techniques for electronic documents. A method includes initiating a collaborative interface comprising a chat interface and a working document editor configured to display content of an electronic document and facilitate edits to the content; obtaining a second electronic document comprising content; obtaining, from the chat interface, a first input comprising a request to provide suggested revisions to the content of the electronic document based on a comparison of the content of the electronic document to the content; sending, to the language model, a prompt to generate a response to the first input; obtaining the response to the prompt, wherein the response comprises a text reply to the first input and the edits to the content of the electronic document; outputting the text reply; and outputting updated content of the electronic document based on the edits from the language model.

### INTRODUCTION

### Technical Field

Aspects of the present disclosure relate to co-editing techniques for electronic documents.

### BACKGROUND

Electronic documents, such as a resume, a cover letter, or other digital documents for business or legal purposes are frequently drafted by a person (e.g., a drafter) interfacing with a word processing application. A drafter may engage a standalone generative artificial intelligence (AI) tool to help develop content for an electronic document. To do this, a drafter may write a prompt that outlines a request for content and submit the prompt to the generative AI tool. In response, the generative AI tool outputs written content and/or graphical content. The drafter may then incorporate the generated content into the document, for example, through a copy and paste action and edit the content to better fit with the document that is being drafted. Generative AI tools can reduce the time and enhance creativity of the writing process by generating content in near-real time in response to a prompt.

There are opportunities to integrate the utilization of generative AI tools into drafting processes that can further improve productivity, creativity, and advance technical capabilities of word processing systems.

### BRIEF SUMMARY

One aspect provides a method for creating a co-edited electronic document, includes initiating a collaborative interface comprising a chat interface and a working document editor configured to display content of an electronic document and facilitate edits to the content, wherein the collaborative interface is operatively coupled with a language model; obtaining a second electronic document comprising content; obtaining, from the chat interface, a first input comprising a request to provide one or more suggested revisions to the content of the electronic document based on a comparison of the content of the electronic document to the content; responsive to obtaining the first input, sending, to the language model, a prompt to generate a response to the first input, wherein the prompt comprises: the first input, the content of the electronic document, and instructions for the language model to generate the response in at least two parts, comprising a first part corresponding to a text reply to the first input and a second part corresponding to one or more edits to the content of the electronic document; obtaining, from the language model, the response to the prompt, wherein the response comprises the text reply to the first input and the one or more edits to the content of the electronic document based on the first input; outputting, for the chat interface, the text reply as an appendage to the first input; and outputting, for the working document editor, updated content of the electronic document based on the one or more edits from the language model.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### DESCRIPTION OF THE DRAWINGS

The aspects set forth in the drawings are illustrative and exemplary in nature and are not intended to limit the subject matter defined by the claims. The following detailed description of the illustrative aspects can be understood when read in conjunction with the following drawings, where like structure is indicated with like reference numerals.

FIG. 1 depicts an example collaborative document system configured to provide co-editing of electronic documents in a collaborative interface having integrated artificial intelligence operatively implemented with one or more computing devices, according to one or more aspects shown and described herein.

FIG. 2 depicts an illustrative collaborative interface, according to one or more aspects shown and described herein.

FIG. 3 depicts a checklist interface of the illustrative collaborative interface depicted in FIG. 2, according to one or more aspects shown and described herein.

FIG. 4 depicts an illustrative interaction diagram for interactions between components of the collaborative document system, according to one or more aspects shown and described herein.

FIG. 5 depicts a flowchart of a method for co-editing electronic documents, according to one or more aspects shown and described herein.

FIG. 6 depicts an example computing device configured to perform co-editing of electronic documents, according to one or more aspects shown and described herein.

### DETAILED DESCRIPTION

Aspects of the present disclosure provide apparatuses, methods, processing systems, and computer-readable mediums for co-editing of electronic documents.

The techniques for co-editing of electronic documents provided in the present disclosure provide integration and utilization of generative AI functionality within a collaborative interface that includes word processing capabilities. The techniques for co-editing of electronic documents described herein deliver a seamless collaborative interface for document creation and/or editing between a user (e.g., a drafter of an electronic document) and generative AI bot(s) (e.g., enabled by generative AI tool(s)). As used herein, a generative AI bot refers to one or more chatbots that use one or more generative AI models to create responses and interactions with the user based on data obtained from the user as well as content from one or more reference electronic documents, such as a job posting, an existing resume or related content, and/or other publications introduced by the user. The techniques for co-editing of electronic documents are directed at improving the integration, utilization, and functionality of word processing based systems by providing a seamless integration of a generative AI tool (or one or more generative AI tools) in a manner that is akin to collaboration between human users with a common electronic document.

As discussed in more detail herein, the seamless integration of the generative AI tool within a collaborative interface, such as within a word processing environment, enables the generative AI tool to provide real-time or near real-time collaborative responses to edits that a user makes to the electronic document since the generative AI tool may be continuously aware of the content of the electronic document and reference materials through its direct integration in the collaborative interface. The reference materials may include, for example, job posting documents, resumes, and/or the like that the user may be working with within the collaborative interface. Additionally, as a user makes changes to the electronic document and/or directly prompts the generative AI tool to assist with generating or editing the electronic document, the generative AI tool can make updates directly to the electronic document without the user having to take additional actions to incorporate the generated content.

Current generative AI tools, which include AI bots, generally operate as standalone tools that interface with a user through a direct prompt that is generated and submitted to the generative AI tool to obtain generated content. However, since current generative AI tools operate as standalone tools, interactions between the generative AI tools, the user, and the other tools, such as a word processing system that the user is utilizing to create an electronic document are disjoint. The disjointedness introduces inefficiencies in the utilization of generative AI tools. That is, interaction with current generative AI tools generally occurs through a chat-thread where a user make requests in the form of prompts to the generative AI tool and the generative AI tool responds in the chat-thread with content corresponding to the prompt. The generated content resides in the chat-thread and should the user want to include this content in the electronic document that is being generated through the word processing system, the user must extract the content from the chat-thread and place it within the electronic document. This interaction is inefficient as the user is required to manually locate the content within the chat-thread, move the content to the electronic document, and in some instances, reformat the content to conform with formatting of the electronic document that they are drafting.

Additionally, since current generative AI tools generally operate as standalone tools, the generative AI tools do not have the capability of providing real-time or near real-time collaborative responses to edits that a user makes to the electronic document. That is, current generative AI tools only operate as a collaborator when the user directly engages the generative AI tool with a prompt. This limits the efficiency that can be obtained from utilizing generative AI tools. Additionally, this limits the ability of generative AI tools to generate and provide content that is consistent with the electronic document that the user is preparing because generative AI tools are not connected to the word processing system.

Aspects of the present disclosure provide a collaborative interface that connects the functionality of a word processing system or other content development application with generative AI tool(s) so that a user may interact with the generative AI tool(s) in manner that enables the generative AI tool(s) to operate as a collaborator as compared to a standalone content generating tool. As discussed in more detail herein, the collaborative interface enables one or more sources of content, such as a job positing, a resume, a cover letter, a transcript, letter(s) of reference, and the like to be incorporated into and accessible through the collaborative interface. This enables the user (e.g., a human drafter) and the generative AI tool(s) to have direct and continuous access to the information being utilized for creation and/or editing of the electronic document within the collaborative interface.

In certain aspects, a user may initiate an instance of the collaborative interface. Initiation may include selecting relevant documents or document sources for use in creating and/or editing an electronic document, such as a resume. The user may directly create and/or edit the electronic document through a working document editor. The user may also engage with the generative AI tool through a chat interface to cause the generative AI tool to operate as a collaborator in creating and/or editing the electronic document.

The collaborative interface can include multiple interface windows including, for example, a word processing application window (also referred to herein as a working document editor), a chat interface, one or more document viewers, a file explorer window, and/or other interfaces. A user may initiate or close interface windows as needed during the creation and/or editing of the electronic document.

Each of the interface windows and the content and functionality provided therethrough is interactable by the user and the generative AI tool in a collaborative manner. In some instances, the user may directly prompt the generative AI tool(s) to perform a task and provide a response to the prompt directly in the appropriate interface windows and content thereof. In some instances, the generative AI tool may automatically take collaborative actions in response to a user's action. For example, a user may select a document, such as a job posting, and incorporate it in the collaborative interface. In response, the generative AI tool may make suggestions for updating or directly edit the electronic document that is being created or edited within the collaborative interface. By way of another example, the generative AI tool can automatically perform formatting operations, content completion, or the like as the user makes edits to the electronic document that is being created or edited within the collaborative interface. The automatic actions that the generative AI tool may take, in response to a user's action within the collaborative interface, may be guided by predefined prompts that are triggered upon the occurrence of user's action. In this way, the user does not need to directly prompt the generative AI tool. For example, in response to a user making an edit to the electronic document, such as defining a section heading, the generative AI tool may automatically generate and populate the section with content, without the user needing to prompt the generative AI tool.

The aforementioned functionality and additional aspects described herein provide a collaborative interface where a generative AI tool can operate as a collaborator with a user within the collaborative interface described herein, as opposed to a standalone tool. The techniques for co-editing of electronic documents within the collaborative interface provide seamless interaction between a user (e.g., the drafter of an electronic document) and the generative AI tool. The interactions enabled by the collaborative interface provides technical solutions for the aforementioned technical problems of using standalone generative AI tool(s), which require direct prompting and manual incorporation of generated content by the standalone generative AI tool into the electronic document being created or edited in a separate application. Aspects of the techniques for co-editing of electronic documents within the collaborative interface provide technical benefits including, but not limited to, real-time or near real-time generated content that can be directly integrated into the electronic document by the generative AI tool. Additional technical benefits include improved efficiency and operability of word processing systems used for creating and/or editing electronic documents.

As used herein, the term “near real-time” refers to events occurring slightly slower than real-time, which refers to instantaneous or action happening at once or concurrently. The term “near-real time” may include a margin of time required for processing to be carried out with a computing device, which in the certain aspects may be the time for the generative AI tool to generate a response to the prompt.

### Example Collaborative Document System

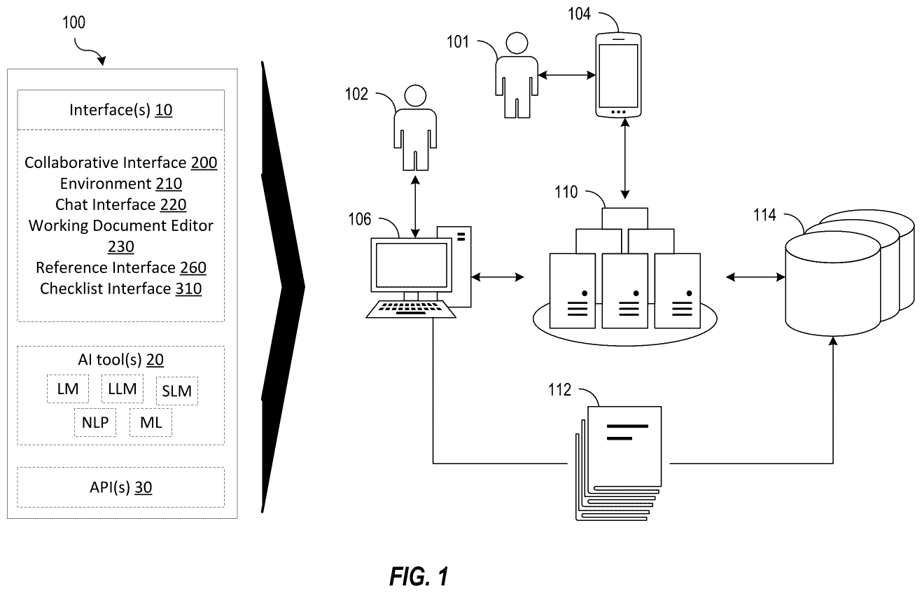

FIG. 1 depicts an example collaborative document system 100 configured to create, edit, retrieve, and generate content for an electronic document between a user and one or more generative AI tools, such as a language model or other artificial intelligence system.

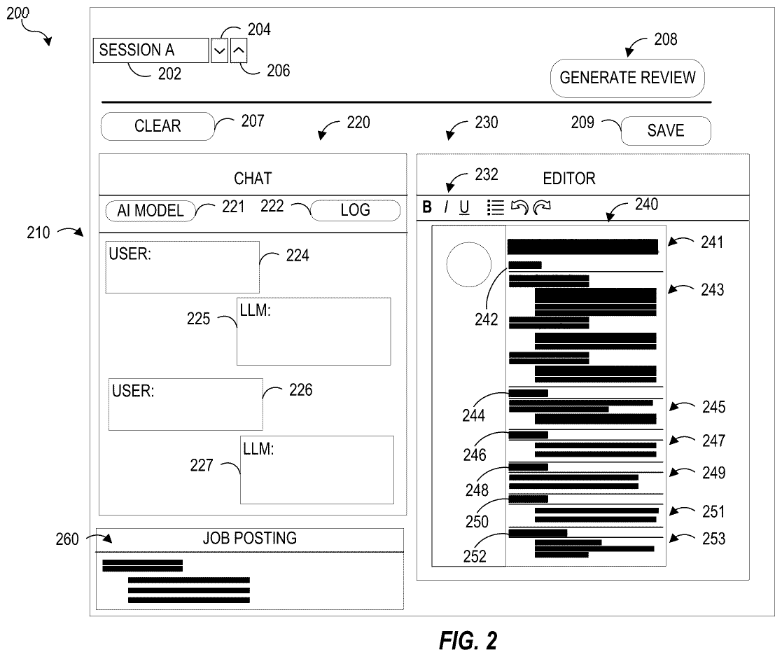

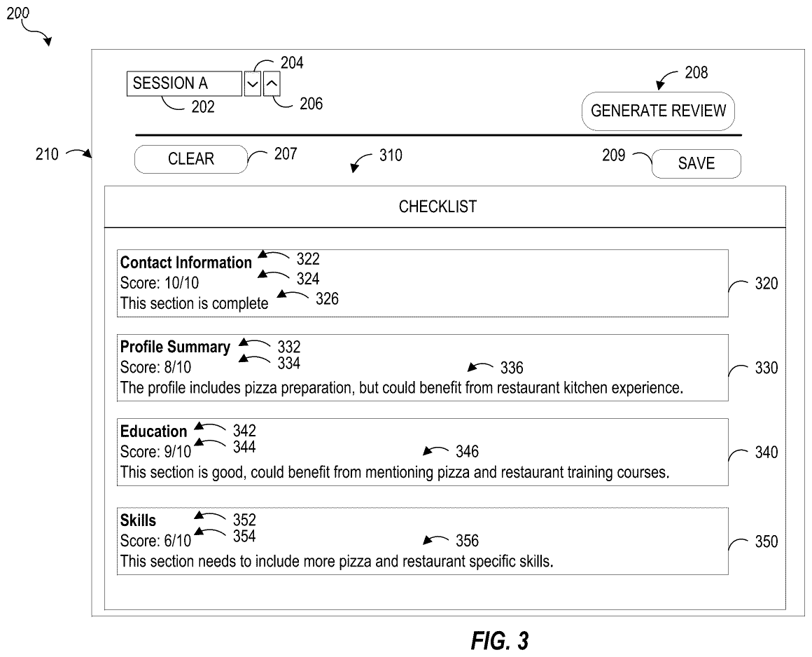

The collaborative document system 100 may be configured with a variety of elements to perform operations and support aspects described herein. In some aspects, elements of the collaborative document system 100 include one or more collaborative interfaces 10, one or more generative AI tools 20, one or more application programming interfaces (APIs) 30, and/or other elements. The one or more collaborative interfaces 10 may include interfaces such as the illustrative collaborative interface 200 for creating and/or editing an electronic document 240 depicted and described with reference to FIG. 2, the checklist interface 310 depicted and described with reference to FIG. 3, and/or multiple other interactive interfaces that enable various functionalities of the collaborative document system 100 to be interacted with by a user and/or generative AI tools 20 as discussed herein. The one or more collaborative interfaces 10 may include chat interface 220 (described with reference to FIG. 2), the working document editor 230 (described with reference to FIG. 2), reference interface 260 (described with reference to FIG. 2), checklists (described with reference to FIG. 3), and/or others. The one or more collaborative interfaces may include graphical user interfaces (UIs), APIs 30, and/or the like that enable the collaborative document system 100 to perform operations and implement aspects described herein. APIs may be utilized by the collaborative document system 100 to coordinate operations between the one or more collaborative interfaces 10, the user and/or generative AI tools 20.

In some aspects, the collaborative document system 100 may host one or more generative AI tools 20 or may utilize one or more APIs to operatively couple to the one or more generative AI tools 20 that may be implemented on a first device 104, a second device 106, and/or one or more computing devices 110.

The collaborative document system 100 may be configured to be interacted with by one or more users (e.g., a first user 101 and second user 102) and/or one or more generative AI tools (e.g., an AI bot) through deployment on a first device 104, a second device 106, and/or one or more computing devices 110. The first user 101 may be a drafter of an electronic document. The second user 102 may be another human drafter or may be an administrator or programmer that may have responsibilities for maintaining and improving the operations of the collaborative document system 100. In some aspects, one or more other users, which may include the first user 104, may perform tasks discussed herein with reference to the second user 102.

The first user 101, through the first device 104, may interact with a collaborative interface 10 of the collaborative document system 100 through a web browser, a local application, a virtual machine, or the like. The first device 104, the second device 106, and/or the one or more computing devices 110, may be a personal computer, a cellular telephone, a PDA, smart device, server(s), virtual machine(s), or the like.

For example, a first user 101 may be a user desiring to create or edit a resume for submitting with a job application. The first user 101 may interface with the collaborative document system 100 via a first device 104, such as a personal computer, a cellular telephone, a PDA, smart device, or the like. A plurality of reference documents 112 may be stored in one or more data storage devices 114 that can be accessed and utilized by the first user 101, through the first device, the second user 102, through the second device 106, and/or the generative AI tool, which may be a language model, for creating, editing, and otherwise utilizing for content in the creation and/or editing of the electronic document, such as the resume in this example. Although resumes and career-related documents are utilized for the examples herein, it is understood that aspects of the disclosure may be utilized in conjunction with any type of electronic document including word processing documents, spreadsheets, presentations, code editors, image generation/manipulation editing documents, and any other electronic file type editable by a person or computing system.

The first user 101 can select and incorporate, for example by linking one or more of the plurality of reference documents 112, into the collaborative interface. The incorporation of reference documents 112 into the collaborative interface enables the users (e.g., human drafters and/or human contributors operating through an electronic device and the generative AI tool, implemented for example as an AI bot) to use content of the reference documents 112 during the collaborative creation or editing of the electronic document. For example, the reference documents 112 may include a job posting, a transcript, a cover letter outlining a job applicant's skills and/or work history, and the like. In some aspects, content that is generated by the generative AI tool may be guided by the content provided the reference documents 112. For example, when the generative AI tool is prompted, either automatically for example, by the creation of a section heading in the electronic document titled “Relevant Work History” or manually by the first user 101 or the second user 102, instead of the generative AI tool arbitrarily suggesting and/or incorporating work history content, the generative AI tool may extrapolate work history content that is guided by the reference documents 112. More specifically, one reference document may be the job posting that outlines particular skills that a job candidate should have. Another reference document may be a cover letter or old resume corresponding to the job candidate that the electronic document (e.g., the resume) that is be created and/or edited in the collaborative interface. Accordingly, in certain aspects, the generative AI tool is configured to tailor creation of content based on the content provided in the reference documents 112, which enables the created content to be relevant to the job candidate and the job posting, for example, that the electronic document (e.g., the resume) is being created for use to submit with an application.

As noted above, the generative AI tool may be implemented by one or more computing devices 110 and accessible through the first device 104 and/or the second device 106, or may exist locally on the first device 104 and/or the second device 106. The one or more computing devices 110 may be configured to implement one or more generative AI tools 20. The generative AI tool 20 may be one or more AI models such as one or more machine learning (ML) models including, but not limited to, one or more language models (LMs), for example including large language models (LLMs) and/or small language models (SLMs). Examples of LMs include, but are not limited to, OpenAI's ChatGPT, NeMO™ LLM from NVIDIA®, LLaMa from Meta®, BERT from Google®, CLAUDE™ from Anthropic A.I., and FLAN-T5 form Google®, or other artificial intelligence or machine learning system capable of being trained on text, code, and/or image datasets that enable the system to understand, generate, and manipulate human language, and perform various natural language processing tasks, and create content upon being prompted. Components of the processes described herein can implement one or more LMs currently developed or that may be developed in the future. In certain aspects, the one or more AI models may include one or more NLP models, such as stsb-roberta-large, paraphrase-mpnet-base, gtr-t5-large or other sentence transformer models. In certain aspects, one or more of the AI models may be selected for use as a co-collaborator in the collaborative interface. The selection may be made by the first user 101 or the second user 102 through a drop-down or other configuration menu within the collaborative interface.

The first device 104 and/or the second device 106 may include a display device for implementing a user interface for a respective user, one or more processors for executing logic, and one or more non-transitory computer-readable mediums for storing information and/or computer readable instructions. The first device 104 and/or the second device 106 may operate as an interface for interacting with processes of the collaborative document system 100. In certain aspects, creation and/or editing processes carried out by the collaborative document system 100 may be performed by one or more computing devices 110. The one or more computing devices 110 may include one or more processors and one or more non-transitory computer-readable mediums storing computer readable instructions that, when executed by the one or more processors, cause the computing device to perform processes defined by computer-readable instructions corresponding to one or more components depicted and described herein.

### Example Collaborative Interface for Electronic Document Creation and Editing

FIG. 2 depicts an illustrative collaborative interface 200 for creating and/or editing an electronic document 240. The collaborative interface 200 is implemented by and interactable through components of the collaborative document system 100 described with reference to FIG. 1 and as further described herein. The collaborative interface 200 is more than a graphical user interface as depicted in FIG. 2. The collaborative interface 200 refers to the visual and the functional aspects that provide a collaborative environment 210 for at least one human user to interact with a generative AI tool, such as a language model configured to collaborate directly on the creation and/or editing of an electronic document 240.

In some aspects, the collaborative interface 200 supports multiple sessions where one or more collaboration sessions for creating and/or editing respective electronic documents can be selectively switched to and from within the collaborative interface 200. For example, in a first session “Session A” a user may initiate the creation of a resume as the electronic document and in a second session “Session B” the user may initiate the editing of a cover letter as the electronic document. The active session that the user is interacting with may be displayed in a text editable frame 202, such that the user can provide a relevant name for the session. A drop-down menu or selectable arrows 204 and 206 enable a user to switch between the sessions. In some embodiments, multiple sessions may be concurrently viewable. Switching between the sessions causes one session to go inactive, but remain open, while causing another session to be become the active session. As discussed in more detail herein, the interactive interfaces of the active session are displayed in the environment 210 of the collaborative interface 200, while the interactive interfaces of the inactive session are removed from view and are not able to be interacted with until that session is reselected as the active session.

The collaborative interface 200 may also include one or more session level tools. Session level tools refer to controls and operations that a user can implement within the collaborative interface 200 to perform desired actions. The session level tools may include a clear tool 207, a generate review tool 208, a save tool 209, and/or other tools. The clear tool 207 may be initiated through a selectable button. The clear tool 207 may cause the content within the environment 210 of the collaborative interface 200 to be cleared. In some aspects, the clear tool 2007 may apply to one of the interactive interfaces within the environment 210 or may apply to more than one, for example, all of the interactive interfaces within the environment 210. The clear tool 207 may enable the user clear the history of a collaboration with the generative AI tool or clear the content of an electronic document being created or edited.

The generate review tool 208 may be initiated through a selectable button. The generate review tool 208 may cause the collaborative interface 200 to perform one or more operations. In some instances, the generate review tool 208 may cause a clean or final version of the electronic document to be presented to the user. In some instances, the generate review tool 208 may cause the generative AI tool to review the electronic document 240 and generate a review report, such as the checklist depicted in the checklist interface 310 of the collaborative interface 200, depicted in FIG. 3. The checklist in the checklist interface 310 will be described in more detail herein, but generally, the checklist can provide a user with a summary of the completeness for various portions of the electronic document, a completeness score, and/or potential suggestions to improve one or more of the various portions of the electronic document.

The save tool 209 may be initiated through a selectable button. The save tool 209 may cause the collaborative interface 200 to save the content within the environment 210. The save tool 209 enables a user to save the content of their active session and optionally close the session so that they may return to it later and resume where they left off. The functionality of the save tool 209 may automatically triggered when a user switches between sessions, for example through a drop-down menu or the selectable arrows 204 and 206.

The collaborative interface 200 provides multiple interactive interfaces. The multiple interactive interfaces enable various functionalities of the collaborative interface 200 to be interacted with by a user and enables reference materials to be incorporated into the environment. As described in more detail herein, reference material that is incorporated into the environment 210 may guide the generative AI tool in the generation of content that is relevant to the particular task, such as creating a resume for a particular job and job candidate, where the job posting and additional information about the job candidate are provided as reference materials in the environment 210.

The multiple interactive interfaces can be initiated, rearranged, closed, and interacted with to provide various functionality to the collaborative process of creating and/or editing of the electronic document 240. The multiple interactive interfaces provide a user the ability to customize the environment 210 of the collaborative interface 200 for the creation and/or editing of the electronic document 240. For example, interactive interfaces may include a chat interface 220 (e.g., also referred to as a resume writer), the working document editor 230 (e.g., also referred to as a resume document or current resume), reference interface 260, checklists (e.g., a checklist interface 310 depicted in FIG. 3), and others. The interactive interfaces may be initiated, rearranged, closed, and interacted with by the user through the collaborative interface 200. In some aspects, two or more of the same type of interactive interface may be initiated. For example, two or more chat interfaces 220 may be initiated. The user may designate one of the chat interfaces 220 as a primary and the other as a second, tertiary, or the like. Each of the chat interfaces 220 may correspond to different generative AI tools, such that the user may collaborate with more than one generative AI tool. In instances where different generative AI tools are initiated, the generative AI tool that is associated with the chat interface 220 designated as primary may be to only generative AI tool to automatically respond to trigger events caused by the user. Trigger events refer to actions, such as a user creating a new section heading within the electronic document, which may cause the generative AI tool to automatically generate and populate the section with content, without the user needing to prompt the generative AI tool, for example, through the chat interface 220.

In certain aspects, the chat interface 220 provides the user with the ability to directly prompt a generative AI tool to carry out a task, provide content, and/or the like, within one or more the session elements. The chat interface 220 may be implemented by a markdown component, such as Plotly Dash, which is a component that renders text formatted using Markdown syntax in the form of a dcc.Markdown object. The chat interface 220 may include an AI model selection menu 221 that enables the user to select between one of a plurality of AI models to interact with through the chat interface 220. The generative AI tool may be one or more AI models such as one or more machine learning models including, but not limited to, one or more language models (LMs), for example including large language models (LLMs) and/or small language models (SLMs). As noted above, examples of LMs include, but are not limited to, OpenAI's ChatGPT, NeMO™ LLM from NVIDIA®, LLaMa from Meta®, BERT from Google®, CLAUDE™ from Anthropic A.I., and FLAN-T5 form Google®. Components of the processes described herein can implement one or more LMs currently developed or that may be developed in the future. In certain aspects, the one or more AI models may include one or more NLP models, such as stsb-roberta-large, paraphrase-mpnet-base, gtr-t5-large or other sentence transformer models.

The generative AI tool may be one or more LLMs and/or one or more SLMs. That is, the generative AI tool is sometimes distinguished between a “large” LM and a “small” LM based on the size and complexity of the model, which affects their capabilities and applications. LLMs are often characterized by their large number of parameters, ranging from hundreds of millions to trillions of parameters. This extensive scale enables them to capture complex language patterns and nuances. LLMs are trained on vast datasets that often include diverse and extensive sources of text from the internet, books, articles, and various other textual corpora (e.g., domain-specific corpora). The large volume of training data contributes to their broad generalization capabilities. Due to their size and comprehensive training, LLMs exhibit excellent language understanding and generation abilities. Relatedly, LLMs require significant computational resources for both training and inference. This includes, for example, powerful hardware such as multiple graphical processing units (GPUs) or tensor processing units (TPUs) and substantial memory and storage capacity.

SLMs have a smaller number of parameters, compared to LLMs, often ranging from tens of thousands to a few hundred million parameters. This relatively smaller size bounds their ability to capture more complex language patterns. SLMs are often trained on smaller datasets compared to LLMs. The training data is typically more focused and less diverse, aimed at specific tasks or domains. While SLMs can still perform various language-related tasks, their performance is usually limited compared to LLMs. However, SLMs require significantly fewer computational resources for training and inference. They can be run on more modest hardware setups, making them suitable for applications with constrained resources or where quick deployment is essential.

Thus, LLMs offer enhanced performance and versatility at the cost of higher computational resource requirements, while SLMs provide a more resource-efficient solution with limitations in performance and capabilities. The choice between an LLM and an SLM depends on the specific application requirements and resource constraints.

The chat interface 220 may also include a log button 222 that enables the user to open a log or history of the interactions with the generative AI tool deployed with the chat interface 220. In some aspects, the log may be provided to the generative AI tool with the prompt so that generative AI tool can generate a response to the prompt that has insight into the previous interactions, so that the generative AI tool can avoid providing the same response or content that was previously considered. An advantage of appending the log to a prompt automatically is that a user can be more conversational with their prompt as interactions develop with the generative AI tool and less detailed or precise in the instructions provided with the prompt because the generative AI tool can ascertain the direction or intent of an interaction with the user from the log. This can greatly increase the efficiency and effectiveness of working with the generative AI tool in the collaboration process of creating and/or editing the electronic document 240. In some aspects, the user may clear the log or remove portions of the log. For example, this may be done when previous actions or interactions with the generative AI tool are no longer relevant or the user does not want the generative AI tool to consider during future interactions.

To directly interact with the generative AI tool, the user may enter text and/or drag-and-drop documents into the chat interface 220. For example, a user may enter text as a first prompt 224. The first prompt 224 may be a request for the generative AI tool to initiate a resume template as an electronic document in the working document editor 230. The generative AI tool may then respond to the first prompt 224 with generated content 225. The generated content 225 may be a conversational response, such as confirmation that a resume template has been generated in the working document editor 230. The generated content 225 may also include one or more questions or prompts back to the user. The one or more questions or prompts may include a request for various information to begin populating the resume template with, such as the name and/or contact information of the candidate of the resume, a job posting that the resume is intended to be used for, or the like. The conversational response is made possible because the generative AI tool ascertained that the topic of the session would be creation of a resume. In this way the generative AI tool is configured to operate in more of a collaboration role as opposed to a reactive role where actions are only taken based on direct prompts provided by the user through the chat interface 220. The user may provide further prompts, such as a second prompt 226, which optionally responds to the one or more questions or prompts in the generated content 225, or the user may proceed with providing additional instruction through in the second prompt 226 that is unrelated to the generative AI tool's generated content 225.

For example, the user may instruct the generative AI tool through the second prompt 226 to populate the resume template based on content provided by one or more references, such as a job posting, a cover letter, a transcript, a candidate's online profile, or the like. The generative AI tool may again respond to the second prompt 226 by taking direct action in editing the resume template within the working document editor 230 and/or providing a response 227 in the chat interface 220. The collaboration may continue in an interactive manner within the chat interface 220 as the user and the generative AI tool collaborate to develop the resume (e.g., the electronic document 240).

In some aspects, the user does not need to enter a prompt in the chat interface 220 to interact with the generative AI tool. In some aspects, the user can directly make edits to the working document editor 230 to the electronic document 240. The working document editor 230 may be configured to operate like a word processing system which provides a user with the ability to preview and edit an electronic document 240. In some aspects, the working document editor 230 may be a Quill object that the user can edit, a rich text editor, or the like. A Quill object is an example of a text editor. In some aspects, the working document editor 230 may provide the user with the ability to select or change the document type by selecting a template through an interactive element. The document template selected may be a resume (e.g., a full resume, a short-version resume, or other defined format for a resume), a job application, a cover letter, or the like. Content may be edited through the text edit box (not shown), which may include selectable items such as skills from an ordered list of skills. Content may be edited directly in the electronic document 240 displayed in the working document editor 230.

The working document editor 230 may provide text-editing tools 232, allowing the user to modify the format, size, style, or the like of the text, add additional information, such as employment dates and the like, and rearrange the content. These are only a few examples of the functionality that a working document editor 230 may provide. Other functionality known in the art of word processing is also contemplated. A save edits button may be configured to save changes made to the content the electronic document 240. The electronic document 240 may be saved in any document format, such as PDF, DOCX, ODF, RTF, TXT, SVG, JPEG, and the like.

As illustrated in FIG. 2, the electronic document 240 is a resume. The resume may include multiple sections optionally defined by a section header 241, 242, 244, 246, 248, 250, and 252 and section content 243, 245, 247, 249, 251, and 253. As discussed in an example herein, the user may define one of the section headers 241, 242, 244, 246, 248, 250, for example, as work history or the like through a direct edit to the electronic document 240 in the working document editor 230. Edits made by the user to the electronic document 240 in the working document editor 230 may automatically cause the generative AI tool to be prompted to perform an operation. For example, when the user defines one of the section headers 241, 242, 244, 246, 248, 250, the generative AI tool may be prompted to generate content in the section content 243, 245, 247, 249, 251, and 253. The generated content may be developed by the generative AI tool based on reference materials, such as a job posting and the like, and/or the log from the chat interface 220 that was developed from interactions between the user and the generative AI tool. Each prompt to the generative AI tool, whether manually generated by the user or automatically triggered based on an action that occurs within the collaborative interface 200, may include the electronic document 240 in its current format. This may be provided in a hypertext markup language (HTML) format or other format so that the generative AI tool obtains not only the content of the electronic document 240, but also the formatting thereof.

The generated content from the generative AI tool may be directly incorporated and formatted into the electronic document 240. The user may then instruct the generative AI tool to take other actions through the chat interface 220 and/or continue editing the electronic document 240 in the working document editor 230, where the generative AI tool may continue to collaborate with the user. In some aspects, the generative AI tool may not directly edit the electronic document 240 but instead provide a suggestion for content or ask the user a question through the chat interface 220. In some aspects, edits that the generative AI tool makes to the electronic document 240 may be displayed in a tracked-changes or annotated format. The tracked-changes format allows a user to see what changes were made by the collaborating party (e.g., the generative AI tool) and subsequently edit or accept the changes.

As creation or editing of the electronic document proceeds in the collaborative interface 200 between a user operating through a computing device such as a first device 104 or a second device 106, and the one or more generative AI tools deployed with the collaborative interface 200, the user may from time to time select the generate review tool 208. When the generate review tool 208 is selected, an interactive interface such as the checklist interface 310 may be initiated and displayed within the environment 210 of the collaborative interface 200, as depicted in FIG. 3. The generate review tool 208 may be configured to cause the generative AI tool to perform one or more various tasks. In some aspects, the generative AI tool may be prompted to review the completeness of portions of the electronic document 240 and depending on the type of document provide a completeness score for each portion. For example, when the electronic document 240 is a resume, each section of the resume may be evaluated for completeness. Completeness may include determining whether there is content in each section, whether the content is relevant to a job posting, and/or whether the content is relevant to the candidate that the resume is being created for.

The collaborative interface 200 depicted in FIG. 3 may include similar features as discussed with reference to FIG. 2. Here, FIG. 3 depicts an illustrative example of the checklist interface 310. The checklist interface 310 may be an interactive interface that can be rearranged with respect to the other interactive interfaces, such as those depicted in FIG. 2, and or otherwise closed or interacted with by the user and/or the generative AI tool. In some aspects, a first portion 320 of the checklist interface 310 may include an evaluation of Contact Information 322 section of the resume. The portion may include the same title as the section header so that it is easy for the user to cross-reference the evaluation in the checklist interface 310 with the corresponding section in the electronic document 240. A first score 324 may be provided. Here, the score is 10/10 which indicates that the section is completed and further edits may not be required. The generative AI tool may also provide a first narrative 326 regarding the section. For example, with respect to the Contact Information 322 section the generative AI tool states “This section is complete.”

For the Profile Summary 330 section, the generative AI tool has indicated a second score 334 of 8/10. The score may consider various parameters, such as relatedness to the job posting, incorporation of relevant information from one or more of the reference materials, language use, style, and/or other parameters. The parameters of the scoring process may be defined by a user or an administrator of the collaborative document system 100. The parameters may include whether the generative AI tool considers certain aspects and rules for how to weigh or evaluate those aspects with respect to other aspects. These parameters may be defined in a predefined prompt that is triggered and provided to the generative AI tool when the generate review tool 208 is selected. The generative AI tool may also provide a second narrative 336 that relates to the Profile Summary 330 section. For example, with respect to the Profile Summary 330 section the generative AI tool states “The profile includes pizza preparation but could benefit from restaurant kitchen experience.” The second narrative 336 provides the user with potentially actionable feedback that can improve the score for the second score 334 for the section. In some instances, the user may ask the generative AI tool, for example, through the chat interface 220 to make updates to the electronic document 240 as suggested in the second narrative 336 of the checklist interface 310.

For the Education 340 section, the generative AI tool has indicated a third score 344 of 9/10. The score may consider various aspects, such as relatedness to the job posting, incorporation of relevant information from one or more of the reference materials, such as information from a transcript, language use, style, and/or other parameters. The generative AI tool may also provide a third narrative 346 that relates to the Education 340 section. For example, with respect to the Education 340 section the generative AI tool states “This section is good, could benefit from mentioning pizza and restaurant training courses.” The third narrative 346 provides the user with potentially actionable feedback that can improve the score for the third score 344 for the section. In some instances, the user may determine that additional reference material should be included, such as a certificate of completion for pizza and restaurant training, and upon incorporating the additional reference material in the collaborative interface 200, ask the generative AI tool, for example, through the chat interface 220 to make updates to the electronic document 240 as suggested in the third narrative 346 of the checklist interface 310 and in view of the additional reference material.

For the Skills 350 section, the generative AI tool has indicated a fourth score 354 of 6/10. The score may consider various aspects, such as relatedness to the job posting, incorporation of relevant information from one or more of the reference materials, such as information from reference letters or previous work experience, language use, style, and/or other parameters. The generative AI tool may also provide a fourth narrative 356 that relates to the Skills 350 section. For example, with respect to the Skills 350 section the generative AI tool states “This section needs to include more pizza and restaurant specific skills.” The fourth narrative 356 provides the user with potentially actionable feedback that can improve the score for the fourth score 354 for the section. In some instances, the user may ask the generative AI tool to provide some examples of pizza and restaurant specific skills that may be relevant to the job posting so that the user can determine whether any are applicable to the candidate associated with the electronic document (e.g., the resume). There may be instances where the user needs some inspiration regarding what content might be relevant, if it is not readily apparent. In this instance, the generative AI tool may ascertain kill recommendations that may be relevant to the particular job, but those that are not clearly indicated as applicable to the job candidate. The suggestions may enlighten a user to an event or activity that would be relevant to include in the Skills 350 section.

### Example Interaction With the Collaborative Interface

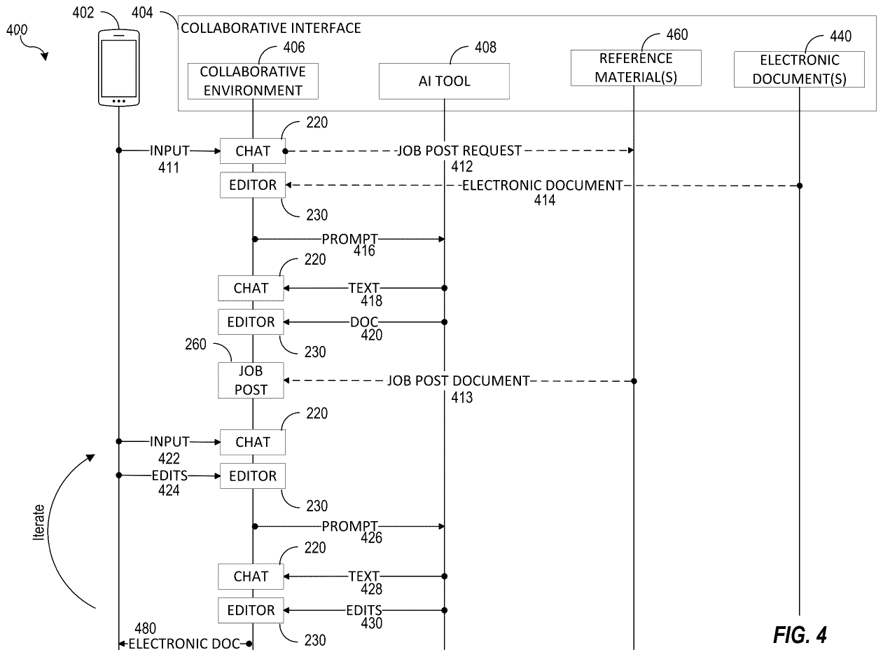

FIG. 4 depicts an illustrative interaction diagram 400 for interactions between components of the collaborative document system 100. Components interacting in the interaction diagram 400 correspond to components of the collaborative document system 100 of FIG. 1. For example, the computing device 402 may be one of the first device 104, the second device 106, the one or more computing devices 110, or other computing device depicted and described with reference to FIG. 1. The collaborative interface 404 corresponds to the collaborative interface 200 of FIG. 2 and components of the collaborative document system 100 configured to implement the collaborative interface 200. The collaborative environment 406 refers to the environment 210 of the collaborative interface 200 and the one or more interactive interfaces implemented therein. The generative AI tool 408 refers to the one or more generative AI tools described herein, including but not limited to AI models, including language models and the like. The reference material component 460 refers to an example of reference material provided through a reference interface 260. In some aspects, the reference material may be a file added to the collaborative interface 404 or may be a file that is accessible by the collaborative interface 404 as the file may be stored on one or more data storage devices 114. The electronic document 440 refers to the electronic document 240 that is being created and/or edited through co-collaboration between at least one user and at least one AI tool with the collaborative interface 404.

While the interaction diagram 400 depicts one example of interactions between components of the collaborative document system 100, variations on the interactions and the order of interactions can vary between sessions. As an example, a user operating through a computing device 402 may initiate a session of the collaborative interface 404. The collaborative interface 404 may be deployed as an application on the computing device 402, through a web browser on the computing device 402, or through other operatively coupled means between the computing device 402 and other computing devices, for example distributed across a network.

Once the collaborative interface 404 is initiated, the user may begin interacting with collaborative interface 404 by initiating one or more interactive interfaces, such as a chat interface 220, a working document editor 230, and the like, as described herein with reference to FIGS. 1-3. The user may add reference materials to the collaborative interface 404 by linking remotely stored files or uploading files to the collaborative interface 404. The reference materials may include, but are not limited to a job posting, a resume, a cover letter, a transcript, a reference letter, candidate notes, and/or the like that the user may be working with within the collaborative interface. These may be added by interacting with the generative AI tool 408 through the chat interface 220. For example, the user may provide an input 411 to the chat interface 220 that requests a job posting 412 be added to the reference material component 460. The user may do this by dragging-and-dropping a copy of the job posting into the chat interface 220 or providing a link to the job posting. The generative AI tool 408 may or may not help facilitate this task through a prompt 416. The input 411 to the chat interface 220 may also include a request for an electronic document 414 that is already created or at least partially created or for a template of an electronic document 414 to be initiated within the working document editor 230. The generative AI tool 408 may or may not help facilitate this task through a prompt 416.

In some aspects, where the generative AI tool 408 assists with facilitating the aforementioned initiation tasks, the generative AI tool 408 may reply with text 418 in the form of conversational text or generated content to the chat interface 220. The generative AI tool 408 may also respond with generating a template 420 of the electronic document 440 in the working document editor 230. In some aspects, the addition of the reference materials, such as a job posting document 413 with the collaborative interface 404 may cause an interactive interface, such as a reference interface 260 to be displayed within the environment of the collaborative interface 404. In some aspects, the generative AI tool 408 may be prompted to search for open job posting that would be a match to the electronic document 480 (e.g., a resume). In certain aspects, the prompt can indicate one or more companies that should be searched. The generative AI tool 408 may be configured to scrape open job positions from job boards of websites of the one or more companies. The open job posting that correspond to the electronic document 480 may be returned to the chat and may be utilized as reference material 460 to further tailor the electronic document 480 for a user. As discussed herein, the job posting document 413 can be displayed within the environment of the collaborative interface 404 and further utilized to customize the electronic document 480 for submitting with an application for the job.

Following at least an initial setup of the environment of the collaborative interface 404, a series of co-collaboration interactions may occur between the user and the generative AI tool 408. The user may provide an input 422 to the chat interface 220 and/or one or more edits 424 to the electronic document in the working document editor 230. These may occur at together or separately in time. In some aspects, only an input 422 is provided by the user, while in other aspects only one or more edits 424 are provided by the user. In any of these occurrences, a prompt 426 may be manually generated (e.g., in response to an input 422) or automatically triggered (e.g., in response to the input 422 or the one or more edits 424). The prompt 426 may also be triggered by selection of a tool, such as the clear tool 207, the generate review tool 208, the save tool 209, or other tool described with reference to FIGS. 2 and 3.

The prompt 426, may include various components. For example, the prompt 426 may include a first input which may be the input 422 from the user or an automatically generated input that corresponds to an action the user took, such as defining a section header in the electronic document. The prompt 426 may also include content of the electronic document 414. This may be in HTML format or similar format, such that content and format may be conveyed in the prompt. The prompt 426 may also include one or more instructions regarding the type of response and/or content that is desired from the generative AI tool 408. In some aspects, the prompt 426 may also include a log of the interactions between the user and the generative AI tool. In some aspects, the prompt 426 may include one or more reference materials that have been incorporated into the collaborative interface 404.

The prompt 426 is provided to the generative AI tool 408. The generative AI tool 408 process the prompt 426 and information indicated by or included in the prompt to generate one or more responses. The generative AI tool 408 may generate a text 428 response that is provided to the chat interface 220. The text 428 response may include conversational text, such as one or more questions or prompts back to the user. The one or more questions or prompts may include a request for various information to begin populating the resume template with, such as the name and/or contact information of the candidate of the resume, a job posting that the resume is intended to be used for, or the like. The conversational response is made possible because the generative AI tool ascertained that the topic of the session would be creation of a resume. In this way the generative AI tool is configured to operate in more of a collaborative role as opposed to a reactive role where actions are only taken based on direct prompts provided by the user through the chat interface 220.

The generative AI tool 408 may also or alternatively generate and implement edits 430 to the electronic document 414 within the working document editor 230. The edits 430 may be implemented in the electronic document 414 in a clean form or in a tracked-changes format so that the user can review, edits, accept, and/or decline the edits 430. The edits 430 may be generated content, changes to formatting of the content in the electronic document, or the like. The generative AI tool 408 may also provide a communication back to the user through the chat interface 220 when making edits 430 to the electronic document 414 so that the user may be aware of what changes were made or further correspond with the generative AI tool 408 to formalize or further adjust the edits 430.

Collaboration between the user and the generative AI tool 408 continues in an iterative manner similar to the process described herein. The aforementioned interactions may occur any number of times until the user is satisfied with the electronic document.

In some aspects, as discussed herein with reference to at least FIG. 3, the user may have the generative AI tool 408 review the electronic document 414 and provide scores and/or further suggestions for edits. The user may prompt, for example, through selection of the generate review tool 208 or directly in the chat interface 220, the generative AI tool to check completeness of the electronic document 414 based on a completeness checklist. The generative AI tool may review the electronic document 414 and return a completeness summary document to the collaborative interface 404 within an interactive interface, such as the checklist interface 310 depicted and described with reference to FIG. 3. The completeness summary document may include for each section of the content of the electronic document 414, a completeness score and/or a comment corresponding to each respective section.

At any time during the collaboration process for creating and/or editing the electronic document, but more likely once the electronic document is completed, the user may download or otherwise obtain a copy of the final electronic document 480 to computing device 402. Obtaining the final electronic document 480 may also include uploading the final electronic document 480 with a job application. It should be understood that while aspects of the collaborative document system 100, the collaborative interface 200 and 404 are described with reference to the creation of a resume for a job application process, there are many other types of electronic documents that can be created and edited using the systems and processes described herein.

### Example Method for Collaborative Creation and Editing of Electronic Documents

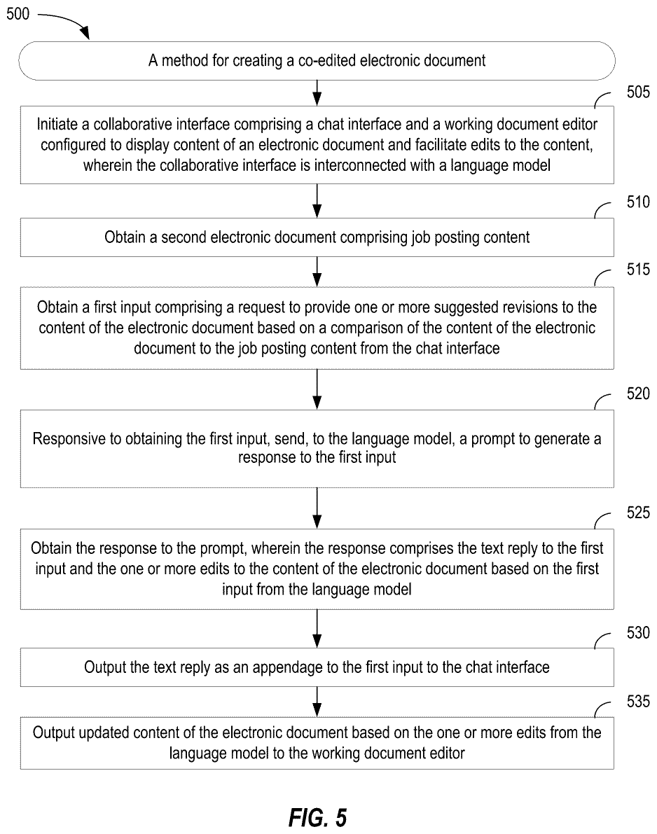

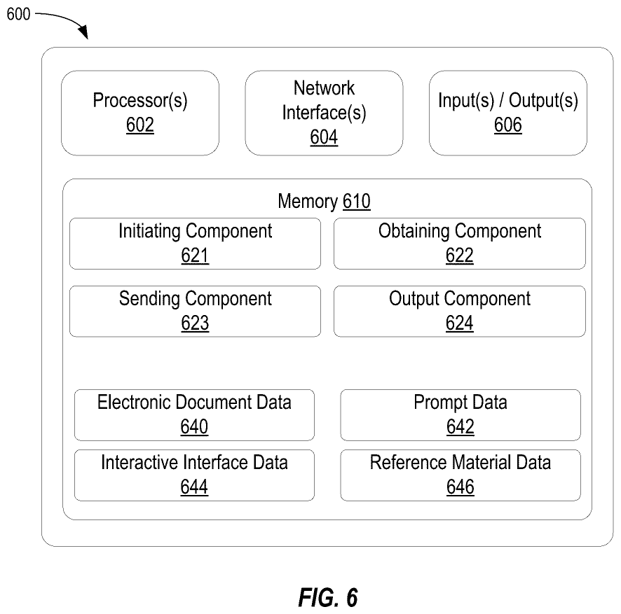

FIG. 5 depicts a flowchart of a method for collaborative creation and editing of electronic documents. In some aspects, the method 500 may be performed by an apparatus, such as the first device 104 and/or the second device 106 of the collaborative document system 100 depicted and described with reference to FIG. 1 and/or the apparatus 600 of FIG. 6, which includes various components operable, configured, or adapted to perform the method 500. Example apparatus 600 is described below in further detail.

Method 500 begins at block 505 with, initiating a collaborative interface comprising a chat interface and a working document editor configured to display content of an electronic document and facilitate edits to the content, wherein the collaborative interface is operatively coupled with a language model. For example, block 505 may be performed by the collaborative document system 100 described above with reference to FIG. 1 that is configured to implement a collaborative interface 200 as depicted and described with reference to FIGS. 2-3 and/or the collaborative interface 404 as depicted and described with reference to FIG. 4.

Method 500 proceed to block 510 with, obtaining a second electronic document comprising content, such as job posting content. For example, block 510 may be performed by the collaborative document system 100 described above with reference to FIG. 1. The second electronic document may be reference materials described with reference to FIGS. 2-4.

Method 500 proceeds to block 515 with, obtaining, from the chat interface, a first input comprising a request to provide one or more suggested revisions to the content of the electronic document based on a comparison of the content of the electronic document to the content, such as job posting content. For example, block 515 may be performed by the collaborative document system 100 described above with reference to FIG. 1. For example, the user may provide an input such as input 411 or 422 to the chat interface 220 with instructions for the generative AI tool 408 to perform a task, such as providing one or more suggested revisions to the content of the electronic document based on a comparison of the content of the electronic document to content, such as the job posting content.

Method 500 proceeds to block 520 with, responsive to obtaining the first input, sending, to the language model, a prompt to generate a response to the first input. In some aspects, the prompt comprises the first input, the content of the electronic document, and instructions for the language model to generate the response in at least two parts, comprising a first part corresponding to a text reply to the first input and a second part corresponding to one or more edits to the content of the electronic document. For example, block 520 may be performed by the collaborative document system 100 described above with reference to FIG. 1. The language model is a generative AI tool 408 that is configured to generate a response the prompt (e.g., prompt 426 depicted and described with reference to FIG. 4 or other prompts described herein).

Method 500 proceeds to block 525 with, obtaining, from the language model, the response to the prompt, wherein the response comprises the text reply to the first input and the one or more edits to the content of the electronic document based on the first input. For example, block 525 may be performed by the collaborative document system 100 described above with reference to FIG. 1. The edit may be one or more edits 430 depicted and described with reference to at least FIG. 4 and throughout the disclosure provided herein.

Method 500 proceeds to block 530 with, outputting, for the chat interface, the text reply as an appendage to the first input. For example, block 530 may be performed by the collaborative document system 100 described above with reference to FIG. 1. The chat interface may be the chat interface 220 described herein. The text reply may be one of the generated content 225 and/or the response 227 depicted and described with reference to FIG. 2 or the text 418 or text 428 depicted and described with reference to FIG. 4.

Method 500 proceeds with block 535 with, outputting, for the working document editor, updated content of the electronic document based on the one or more edits from the language model. For example, block 535 may be performed by the collaborative document system 100 described above with reference to FIG. 1. The working document editor may be the working document editor 230 depicted and described with reference to FIGS. 2 and 4. The edits may be the edits 430 depicted and described with reference to FIG. 4 or other edits described herein.

In some aspects, the method 500 further includes obtaining, through the working document editor, one or more revisions to the content of the electronic document.

In some aspects, the first input comprises a request to guide content creation for the content of the electronic document, wherein the electronic document is a resume, and responsive to the request to guide content creation for the resume, the method 500 further includes obtaining, from the language model for the chat interface, a sequence of responses corresponding to sections of the resume, wherein each response in the sequence of responses either requests information for the content of the electronic document or provides suggested content within the electronic document provided within the working document editor.

In some aspects, the method 500 further includes initiating, for the collaborative interface, a second electronic document editor, wherein the second electronic document editor is configured to display the content, such as job posting content.

In some aspects, the text reply comprises the one or more suggested revisions, wherein the one or more suggested revisions comprise at least one of a job skill, a job experience, or a summary to add to the content of the electronic document.

In some aspects, the first input comprises a request to check completeness of the electronic document based on a completeness checklist, and the method 500 further includes: obtaining, from the language model, a completeness summary document, wherein the completeness summary document comprises, for each section of the content of the electronic document, a completeness score and a comment corresponding to each respective section and outputting, for the collaborative interface, the completeness summary document in an interface separate from the chat interface.

In some aspects, obtaining, with the language model, the completeness summary document is based on a comparison of the content of the electronic document to content, such as job posting content.

In some aspects, the prompt further comprises a chat history comprising inputs and corresponding responses to the inputs preceding the first input in a present session of the collaborative interface, and the response to the prompt, from the language model, is based on the chat history.

In some aspects, the chat interface is implemented by a markdown component and the working document editor is implemented by a text editor.

In some aspects, the method 500 further includes obtaining a selection of the language model from a plurality of language models, wherein the selection of the language model is operatively coupled with the collaborative interface.

Method 500 thus provides technical solutions to several technical challenges and shortcomings related to utilizing generative AI tools by providing techniques co-editing of electronic documents within a seamless collaborative interface. The techniques for co-editing of electronic documents improve the integration, utilization, and functionality of word processing based systems by providing a seamless integration of a generative AI tool (or one or more generative AI tools) in a manner enables a user to interact with the generative AI tool in a co-collaborative manner. The techniques enable more efficient creation of electronic documents and improve the interaction with generative AI tools since the generative AI tool is integrated with the environment that the user utilizes for drafting.

### Example Apparatus

FIG. 6 depicts an example apparatus 600 configured to perform methods described herein. The example apparatus 600 depicted in FIG. 6 may be the first device 104 and/or the second device 106 of the collaborative document system 100 depicted and described herein and with reference to FIG. 1.

The example apparatus 600 includes one or more processors 602. Generally, processor(s) 602 may be configured to execute computer-executable instructions (e.g., software code) to perform various functions, as described herein.

The example apparatus 600 further includes a network interface(s) 604, which generally provides data access to any sort of data network, including personal area networks (PANs), local area networks (LANs), wide area networks (WANs), the Internet, and the like.

The example apparatus 600 further includes input(s) and output(s) 606, which generally provide means for providing data to and from the example apparatus 600, such as via connection to computing device peripherals, including user interface peripherals.

The example apparatus 600 further includes a memory 610 configured to store various types of components and data.

In this example, memory 610 includes an initiating component 621, obtaining component 622, sending component 623, and outputting component 624.

Initiating component 621 may be configured to perform processes, for example, corresponding to block 505 of method 500 depicted and described with reference to FIG. 5. Obtaining component 622 may be configured to perform processes, for example, corresponding to block 510, block 515, and block 525 of method 500 depicted and described with reference to FIG. 5. Sending component 623 may be configured to perform processes, for example, corresponding to block 520 of method 500 depicted and described with reference to FIG. 5. Outputting component 624 may be configured to perform processes, for example, corresponding to block 530 and block 535 of method 500 depicted and described with reference to FIG. 5.

In this example, memory 610 also includes electronic document data 640 (e.g., an electronic document or an electronic document template, such as a resume or the like), prompt data 642 (e.g., prompt 426 and the like described herein), interactive interface data 644 (e.g., data defining the structures and content of the environment 210), and reference material data 646 (e.g., job posting, resume, cover letter, and/or the like).

The example apparatus 600 may be implemented in various ways. For example, the example apparatus 600 may be implemented within on-site, remote, or cloud-based computing devices.

The example apparatus 600 is just one example, and other configurations are possible. For example, in alternative embodiments, aspects described with respect to the example apparatus 600 may be omitted, added, or substituted for alternative aspects.

### EXAMPLE CLAUSES

Implementation examples are described in the following numbered clauses:

Clause 1: A method for creating a co-edited electronic document, comprising initiating a collaborative interface comprising a chat interface and a working document editor configured to display content of an electronic document and facilitate edits to the content, wherein the collaborative interface is operatively coupled with a language model; obtaining a second electronic document comprising content; obtaining, from the chat interface, a first input comprising a request to provide one or more suggested revisions to the content of the electronic document based on a comparison of the content of the electronic document to the content; responsive to obtaining the first input, sending, to the language model, a prompt to generate a response to the first input, wherein the prompt comprises: the first input, the content of the electronic document, and instructions for the language model to generate the response in at least two parts, comprising a first part corresponding to a text reply to the first input and a second part corresponding to one or more edits to the content of the electronic document; obtaining, from the language model, the response to the prompt, wherein the response comprises the text reply to the first input and the one or more edits to the content of the electronic document based on the first input; outputting, for the chat interface, the text reply as an appendage to the first input; and outputting, for the working document editor, updated content of the electronic document based on the one or more edits from the language model.

Clause 2: The method of Clause 1, further comprising obtaining, through the working document editor, one or more revisions to the content of the electronic document.

Clause 3: The method of any one of Clauses 1-2, wherein the first input comprises a request to guide content creation for the content of the electronic document, wherein the electronic document is a resume; and responsive to the request to guide content creation for the resume, obtaining, from the language model for the chat interface, a sequence of responses corresponding to sections of the resume, wherein each response in the sequence of responses either requests information for the content of the electronic document or provides suggested content within the electronic document provided within the working document editor.

Clause 4: The method of any one of Clauses 1-3, further comprising initiating, for the collaborative interface, a second electronic document editor, wherein the second electronic document editor is configured to display the content.

Clause 5: The method of Clause 4, wherein the text reply comprises the one or more suggested revisions, wherein the one or more suggested revisions comprise at least one of a job skill, a job experience, or a summary to add to the content of the electronic document.

Clause 6: The method of any one of Clauses 1-5, the first input comprises a request to check completeness of the electronic document based on a completeness checklist, and the method further comprises: obtaining, from the language model, a completeness summary document, wherein the completeness summary document comprises, for each section of the content of the electronic document, a completeness score and a comment corresponding to each respective section; and outputting, for the collaborative interface, the completeness summary document in an interface separate from the chat interface.

Clause 7: The method of Clause 6, wherein obtaining, with the language model, the completeness summary document is based on a comparison of the content of the electronic document to content.

Clause 8: The method of any one of Clauses 1-7, wherein the prompt further comprises a chat history comprising inputs and corresponding responses to the inputs preceding the first input in a present session of the collaborative interface; and the response to the prompt, from the language model, is based on the chat history.

Clause 9: The method of any one of Clauses 1-8, wherein the chat interface is implemented by a markdown component and the working document editor is implemented by a text editor.

Clause 10: The method of any one of Clauses 1-9, further comprising obtaining a selection of the language model from a plurality of language models, wherein the selection of the language model is operatively coupled with the collaborative interface.

Clause 11: A processing system, comprising means for performing a method in accordance with any one of Clauses 1-10.

Clause 12: A non-transitory computer-readable medium comprising computer-executable instructions that, when executed by a processor of a processing system, cause the processing system to perform a method in accordance with any one of Clauses 1-10.

Clause 13: A computer program product embodied on a computer-readable storage medium comprising code for performing a method in accordance with any one of Clauses 1-10.

### ADDITIONAL CONSIDERATIONS

The description provided above is intended to be illustrative and non-limiting. Thus, it will be apparent to one skilled in the art that modifications may be made to the present disclosure as described without departing from the scope of the claims set out below. Moreover, while the above description was provided with reference to the creation of enhanced documents and online documents, the disclosure is not thus limited, and may be naturally extended to other contexts.

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

It will be apparent to those skilled in the art that various modifications and variations can be made in the present disclosure without departing from the spirit or scope of the disclosure. Thus, it is intended that the present disclosure cover the modifications and variations of this disclosure provided they come within the scope of the appended claims and their equivalents.

While various aspects of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary aspects, but should be defined only in accordance with the following claims and their equivalents.

What is claimed is:

1. A method for creating a co-edited electronic document, comprising:
initiating a collaborative interface comprising a chat interface and a working document editor configured to display content of an electronic document and facilitate edits to the content, wherein the collaborative interface is operatively coupled with a language model;
obtaining a second electronic document comprising content;
obtaining, from the chat interface, a first input comprising a request to provide one or more suggested revisions to the content of the electronic document based on a comparison of the content of the electronic document to the content;
responsive to obtaining the first input, sending, to the language model, a prompt to generate a response to the first input, wherein the prompt comprises:
the first input,
the content of the electronic document, and
instructions for the language model to generate the response in at least two parts, comprising a first part corresponding to a text reply to the first input and a second part corresponding to one or more edits to the content of the electronic document;
obtaining, from the language model, the response to the prompt, wherein the response comprises the text reply to the first input and the one or more edits to the content of the electronic document based on the first input;
outputting, for the chat interface, the text reply as an appendage to the first input; and
outputting, for the working document editor, updated content of the electronic document based on the one or more edits from the language model.

2. The method of claim 1, further comprising obtaining, through the working document editor, one or more revisions to the content of the electronic document.

3. The method of claim 1, wherein:
the first input comprises a request to guide content creation for the content of the electronic document, wherein the electronic document is a resume; and
responsive to the request to guide content creation for the resume, obtaining, from the language model for the chat interface, a sequence of responses corresponding to sections of the resume, wherein each response in the sequence of responses either requests information for the content of the electronic document or provides suggested content within the electronic document provided within the working document editor.

4. The method of claim 1, further comprising initiating, for the collaborative interface, a second electronic document editor, wherein the second electronic document editor is configured to display the content.

5. The method of claim 4, wherein the text reply comprises the one or more suggested revisions, wherein the one or more suggested revisions comprise at least one of a job skill, a job experience, or a summary to add to the content of the electronic document.

6. The method of claim 1, wherein:
the first input comprises a request to check completeness of the electronic document based on a completeness checklist, and
the method further comprises:
obtaining, from the language model, a completeness summary document, wherein the completeness summary document comprises, for each section of the content of the electronic document, a completeness score and a comment corresponding to each respective section; and
outputting, for the collaborative interface, the completeness summary document in an interface separate from the chat interface.

7. The method of claim 6, wherein obtaining, with the language model, the completeness summary document is based on a comparison of the content of the electronic document to content.

8. The method of claim 1, wherein:
the prompt further comprises a chat history comprising inputs and corresponding responses to the inputs preceding the first input in a present session of the collaborative interface; and
the response to the prompt, from the language model, is based on the chat history.

9. The method of claim 1, wherein the chat interface is implemented by a markdown component and the working document editor is implemented by a text editor.

10. The method of claim 1, further comprising:
obtaining a selection of the language model from a plurality of language models, and
wherein the selection of the language model is operatively coupled with the collaborative interface.

11. A processing system, comprising:
one or more memories comprising computer-executable instructions; and
one or more processors configured to execute the computer-executable instructions causing the processing system to:
initiate a collaborative interface comprising a chat interface and a working document editor configured to display content of an electronic document and facilitate edits to the content, wherein the collaborative interface is operatively coupled with a language model;
obtain a second electronic document comprising content;
obtain, from the chat interface, a first input comprising a request to provide one or more suggested revisions to the content of the electronic document based on a comparison of the content of the electronic document to the content;
responsive to obtaining the first input, send, to the language model, a prompt to generate a response to the first input, wherein the prompt comprises:
the first input,
the content of the electronic document, and
instructions for the language model to generate the response in at least two parts, wherein the at least two parts comprise a first part corresponding to a text reply to the first input and a second part corresponding to one or more edits to the content of the electronic document;
obtain, from the language model, the response to the prompt, wherein the response comprises the text reply to the first input and the one or more edits to the content of the electronic document based on the first input;
output, for the chat interface, the text reply as an appendage to the first input; and
output, for the working document editor, updated content of the electronic document based on the one or more edits from the language model.

12. The processing system of claim 11, wherein the processing system is further configured to obtain, through the working document editor, one or more revisions to the content of the electronic document.

13. The processing system of claim 11, wherein:
the first input comprises a request to guide content creation for the content of the electronic document, wherein the electronic document is a resume; and
responsive to the request to guide content creation for the resume, the processing system is further configured to obtain, from the language model for the chat interface, a sequence of responses corresponding to sections of the resume, wherein each response in the sequence of responses either requests information for the content of the electronic document or provides suggested content within the electronic document provided within the working document editor.

14. The processing system of claim 11, wherein the processing system is further configured to initiate, for the collaborative interface, a second electronic document editor, wherein the second electronic document editor is configured to display the content.

15. The processing system of claim 14, wherein the text reply comprises the one or more suggested revisions, wherein the one or more suggested revisions comprise at least one of a job skill, a job experience, or a summary to add to the content of the electronic document.

16. The processing system of claim 11, wherein:
the first input comprises a request to check completeness of the electronic document based on a completeness checklist, and
the processing system is further configured to:
obtain, from the language model, a completeness summary document, wherein the completeness summary document comprises, for each section of the content of the electronic document, a completeness score and a comment corresponding to each respective section; and
output, for the collaborative interface, the completeness summary document in an interface separate from the chat interface.

17. The processing system of claim 16, wherein to obtain, with the language model, the completeness summary document is based on a comparison of the content of the electronic document to content.

18. The processing system of claim 11, wherein:
the prompt further comprises a chat history comprising inputs and corresponding responses to the inputs preceding the first input in a present session of the collaborative interface; and
the response to the prompt, from the language model, is based on the chat history.

19. The processing system of claim 11, wherein the chat interface is implemented by a markdown component and the working document editor is implemented by a text editor.

20. The processing system of claim 11, wherein the processing system is further configured to:
obtain a selection of the language model from a plurality of language models, and
wherein the selection of the language model is operatively coupled with the collaborative interface.
